(19) United States
(12) Patent Application Publication
(10) Pub. No.: US 2026/0112125 A1
(43) Pub. Date: Apr. 23, 2026

(54) METHOD AND APPARATUS FOR EXTENDED REALITY CAPTURE AND DISPLAY USING DISTRIBUTED ARCHITECTURE

(71) Applicants: Robert Bosch GmbH, Stuttgart (DE); Carnegie Mellon University, Pittsburgh, PA (US)

(72) Inventors: Sruti SRINIDHI, Pittsburgh, PA (US); Edward LU, Pittsburgh, PA (US); Emily RUPPEL, Pittsburgh, PA (US); Anthony ROWE, Pittsburgh, PA (US)

(21) Appl. No.: 18/922,181

(22) Filed: Oct. 21, 2024

(51) Int. Cl. G06T 19/00; G06F 40/40; G06T 7/70; G06T 17/20

(52) U.S. Cl. CPC G06T 19/006; G06F 40/40; G06T 7/70; G06T 17/20; G06T 2200/04; G06T 2207/10016

(57) ABSTRACT

A method and apparatus for using an XR device for capture and display using a distributed architecture with LLMs is disclosed. A method includes capturing, in an environment and using an XR device, sensor data from a plurality of sensors, wherein the sensor data includes image, audio, and depth data. Using the sensor data, a world mesh corresponding to a three-dimensional geometric representation of the environment if formed. Based on the image data, pose data indicating respective positions and orientations of a plurality of objects present in the world mesh is generated. Speech in the audio data is converted into text. Using the text data and image data, a prompt is created. LLMs, using the prompt, are executed and generate a text output, which is provided to the XR device to produce a visual output.

### TECHNICAL FIELD

The present disclosure relates to extended reality (XR) headsets, and more particularly, the use of multi-modal large language models (MLLMs) with XR headsets.

### BACKGROUND

Extended reality comprises a number of different immersive technologies that includes virtual reality (VR), augmented reality (AR), and mixed reality (MR). Using these technologies, the physical and digital (or virtual) worlds may be blended to a certain degree to create various interactive experiences.

VR comprises a fully immersive experience in which a user may be places (in a sensorial perspective) into a virtual environment. A user may wear a headset that blocks at least some real-world sensory inputs (such as sight and sound), replacing these with inputs from a simulated environment. Visually, the environment may include a simulated three-dimensional environment in a user's field of view. VR is commonly used in gaming and training simulations.

In AR, digitally generated elements are overlaid a view of the real world. An AR user may use a device (such a headset or smartphone) that does not block out real-world sensor inputs. Instead, AR may add computer generated content to, e.g., a view of the real world. A notable AR game provided as a mobile app is Pokémon Go.

MR combines elements of both AR and VR, thereby allowing real-time interaction between real world objects (e.g., in the field of view of a user) and virtual world objects (generated using a device capable of generating VR).

XR technologies using various combinations of the elements described above may be implemented in, e.g., certain types of headsets. Using such technologies, spatial mapping may be carried out to allow images of digital objects may be overlaid onto a view of the real world while allowing users to interact with them using hand gestures, eye tracking, voice commands, and so on. Such devices may be used in fields such as entertainment, training, healthcare, and industrial applications, providing immersive experiences that can bridge physical and virtual environments.

### SUMMARY

A method and apparatus for using an XR device for capture and display using a distributed architecture with LLMs is disclosed. In one embodiment, a method includes capturing, in an environment and using an extended reality device, sensor data from a plurality of sensors of the extended reality device, wherein the sensor data includes image data, audio data, and depth data. The method further includes forming, using the sensor data, a world mesh corresponding to a three-dimensional geometric representation of the environment and generating, based on the image data, pose data indicating respective positions and orientations of a plurality of objects present in the world mesh. The method also includes converting speech in the audio data into text data. Thereafter, the method includes creating, using the text data and selected image data, a prompt and executing, in parallel and using the prompt, a plurality of large language models (LLMs) to generate a text output. Based on the executing, the method includes combining, in the extended reality device, the text output and a three-dimensional projection generated based on the world mesh and pose data to produce a visual output and providing the visual output to a display of the extended reality device.

### BRIEF DESCRIPTION OF THE DRAWINGS

FIG. 1 shows a system 100 for training a neural network.

FIG. 2 shows a computer-implemented method 200 for training a neural network.

FIG. 3A is diagram illustrating one embodiment of a system for utilizing LLMs with an XR device.

FIG. 3B is a diagram illustrating a method for operating one embodiment of system utilizing LLMs with an XR device.

FIG. 3C is a flow diagram of one embodiment of a method for operating an XR device.

FIG. 4A is a diagram illustrating the operation of an application using an XR device and LLMs.

FIG. 4B is a diagram further illustrating the operation of an application using an XR device and LLMs.

FIG. 4C is a diagram illustrating an example of a web-based dashboard for human assessment of performance of the system disclosed herein.

FIG. 5 depicts a schematic diagram of an interaction between computer-controlled machine 510 and control system 512.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application.

Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Extended reality (XR) devices may enhance a user's interaction with an environment in an immersive way. Types of XR devices includes headsets, glasses, smartphones, tablets, and heads-up displays, and include a local processor for processing various types of data, such as image data and audio data. However, the processing power in an XR device is limited with regard to some functions. For example, typical XR devices lack the processing power to run large language models (LLMs), including multimodal LLMs (MLLMs, which ingest multiple data types such as image data and audio data). Typical LLMs are resource intensive and are unable to run efficiently on mobile XR devices.

As advancements continue in the development of general-purpose LLMs, considerable efforts have been directed towards enabling their operation on mobile platforms. These efforts may include quantization and sparsification. While this improves memory usage, lowers latency, and reduces network demands, it does so at the expense of decreased descriptiveness, accuracy, and general applicability. On the other hand, robust LLMs may utilize billions and trillions of parameters. Such LLMs may be trained on vast datasets, enabling them to offer more detailed and imaginative responses across a broad spectrum of topics. However, their size renders them unable to run on edge devices such as mobile XR devices. Instead, the processing power required currently necessitates running LLMs to be run on powerful servers.

The present disclosure, recognizing the limitations of running LLMs on edge devices such as XR headsets, combines their functionality while performing LLM processing in the cloud while handling XR-related tasks on the headset on the XR device. This in turn provides balancing performance and resource usage.

An example application of the method disclosed herein is a “Cognitive Assistant” that displays step-by-step instructions for performing a task, only updating the instructions once it has confirmed that a user has completed a particular step of the process. Despite significant strides in developing such instruction-following assistants in XR, many of these systems need extensive manual effort to craft XR instructions for each specific task. These processes are labor-intensive and lack adaptability across varying tasks. Moreover, these systems often offer fixed responses, lacking the capability to dynamically adjust guidance based on user interactions. Various implementations of the method disclosed herein may overcome these problems.

LLMs have demonstrated significant potential to power virtual assistants across various domains such as programming, personal tasks, and medical diagnosis. However, recent advancements in multimodal artificial intelligence (AI) and perception techniques have led to “intelligent” assistants, capable of interpreting and responding to the physical environment with tailored responses. For example, certain types of glasses may leverage AI inference to analyze images captured by the glasses and can provide insights into the user's surroundings. Similarly, certain AI assistants may perceive and respond in the context of the user's physical environment using visual and audio prompts. While these types of systems excel at perceiving the environment, they are limited to displaying a fixed, static output, and lack the capability to dynamically project and anchor responses back into the environment.

The methods and systems of the present disclosure may overcome these issues by dividing the processing tasks between an XR device and processing of LLMs in a cloud or data center. Various embodiments are now discussed in further detail.

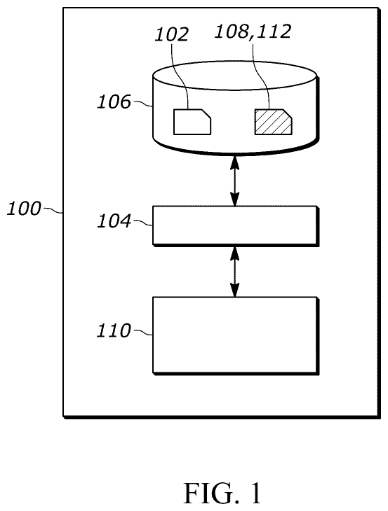

FIG. 1 shows a system 100 for training a neural network, e.g., a deep neural network. The neural network or deep neural networks shown and described are merely examples of the types of machine-learning networks or neural networks that can be used. The system 100 may comprise an input interface for accessing training data 102 for the neural network. For example, as illustrated in FIG. 1, the input interface may be constituted by a data storage interface 104, which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part.

The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system for training a neural network may be used in applications that include performing LLM processing for a XR device. Training may be conducted on audio data and image data from the XR device. The training may include the generation of prompts using image and audio data from the XR device, with further training on one or more LLMs using the prompt, and in some instances, along with text (from speech-to-text conversion) and image data. The LLMs may be MLLMs in some embodiments, and may generate a text output that can be provided back to the XR device. The text output may be utilized to, e.g., provide instructions or directions to a user of the XR device, generate AR overlays, and so on.

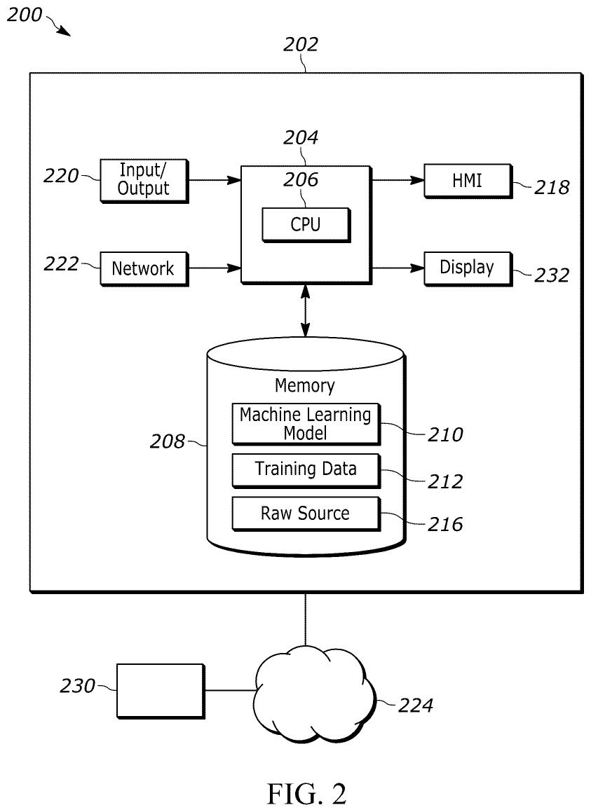

FIG. 2 depicts a system 200 to implement the machine-learning models described herein, for example the deep neural networks used in, e.g., LLMs/MLLMs used in conjunction with XR devices. Other types of machine-learning models can be used, and the DNNs described herein are not the only types of machine-learning models capable of being used in the system of this disclosure. For example, if an input image associated with a process controlled by a PLC contains an ordered sequence of pixels after converting CSI values to pixels in an image), a CNN may be utilized.

The system 200 can be implemented to perform one or more of the phases of operation described herein in which LLM/MLLM processing is performed in conjunction using date received from an XR device, with the results of the processing returned to the XR device. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more devices 230, such as an XR device, may be in communication with the external network 224. The external network may facilitate two-way communication between the one or more devices and the computing system 202. For example, the external network 224 may facilitate communication between computing system and an XR device in accordance with the disclosure herein, receiving image and audio data and returning data from the execution of one or more LLMs/MLLMs by computing system 202.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines, which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as an XR device (e.g., glasses, headset) but may also include keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), raw or partially processed sensor data (e.g., radar map of objects), wireless signals in terms of CSI, RSSI, CIR. Moreover, the raw source dataset 216 may be input data derived from an associated sensor such as a camera, LiDAR, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. Other types of sensors, such as temperature and pressure sensors, may also provide various inputs to the system. Several different examples of inputs are shown and described with reference to the other drawings of the present disclosure. In some examples, the machine-learning algorithm 210 may be a neural network algorithm (e.g., deep neural network) that is designed to perform a predetermined function. For example, the neural network algorithm may be configured to identify defects (e.g., cracks, stresses, bumps, etc.) in a part subsequent to the manufacture of that part but prior to leaving the plant.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify certain aspects of a manufacturing process carried out by automated equipment under control of a program executed by a PLC. In another example, the machine-learning algorithm 210 may be configured to identify the presence of a defect in a manufactured part, produced by an automated process under control of a PLC program, by capturing images of that part. The machine-learning algorithm 210 may be programmed to process the raw source data 216 to identify the presence of the particular features. The machine-learning algorithm 210 may be configured to identify a feature in the raw source data 216 as a predetermined feature (e.g., obstacle, pedestrian, road sign, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera and raw audio data received from an XR device.

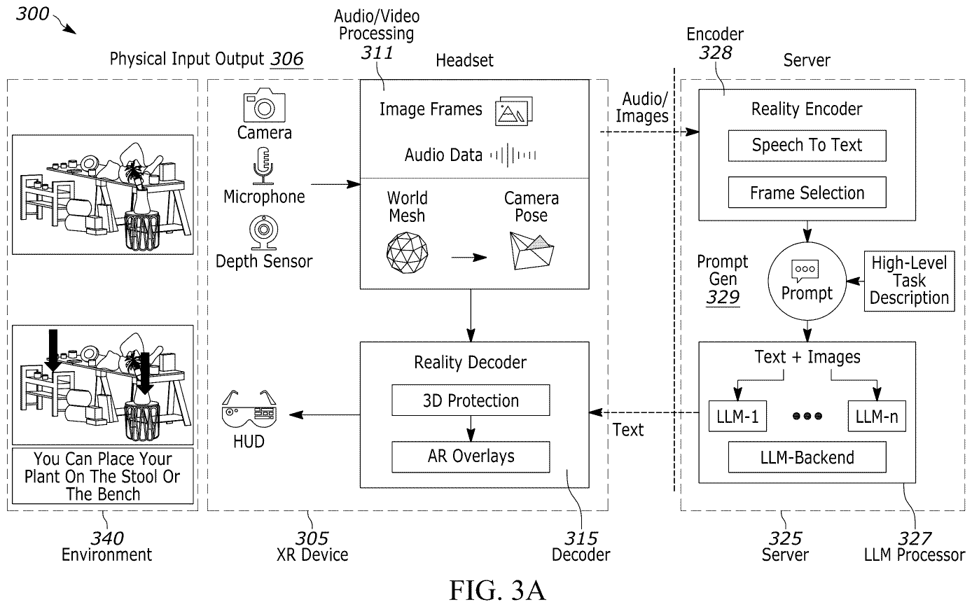

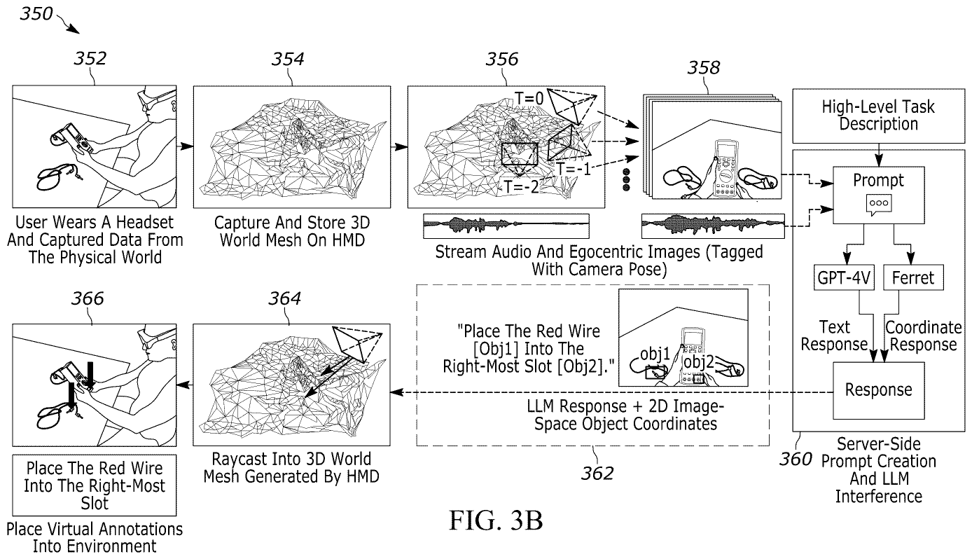

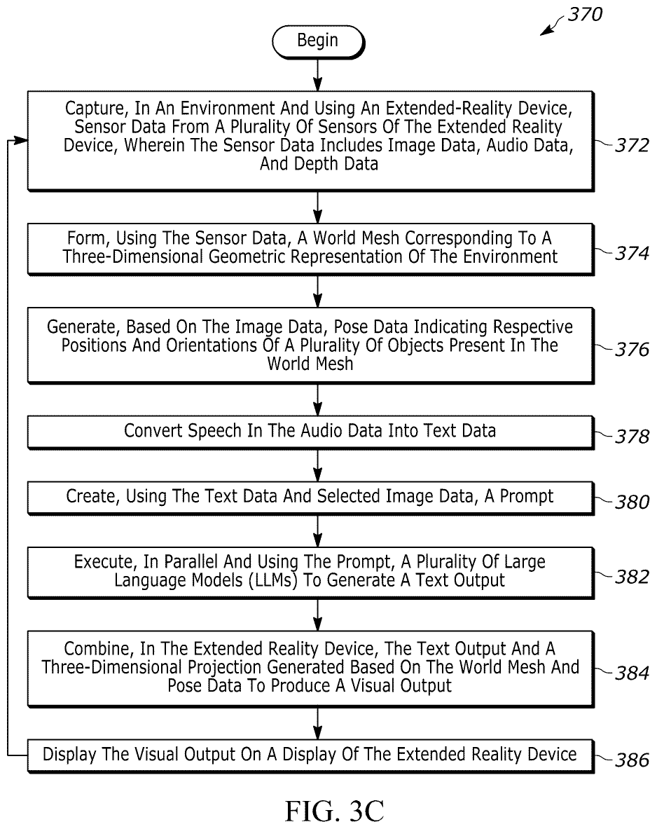

FIG. 3A is diagram illustrating one embodiment of a system for utilizing LLMs with an XR device. In the illustrated example, system 300 includes an XR device 305 that interacts with an environment 340 and is further configured to communicate with a server 325. In various embodiments, server 325 is located remotely from XR device 305, although bi-directional communications between the two over various channels is carried out during the operation described herein. Data sent from XR device 305 to server 325 is applied to one or more LLMs (e.g., MLLMs), which return text information to XR device 305. Using the text information from the LLM processing, XR device may carry out various actions, such as displaying instructions on an AR overlay viewable by a user of XR device 305.

As shown in FIG. 3A, XR device 311 includes an audio/video processing unit 311 and physical input/output (I/O) 306, which comprises various sensors including a camera, a microphone, and a depth sensing camera. These sensors may be part of, e.g., a headset or smart glasses, which also includes a heads-up display (HUD). XR device 305 further includes an audio/video processing unit 311 and a decoder unit 315. These units may be implemented in XR devices 311 using any suitable combination of software, hardware, and/or firmware. Server 325 includes an encoder 328, a prompt generator 329, and an LLM processor 327. These units may also be implemented using any suitable combination of software, hardware, and/or firmware.

The various sensors that are part of XR device 305 capture information about the physical world, which is subsequently passed to server 325 for further processing. The information is processed by the headset to produce a world mesh and estimate the pose of the cameras as well as to perform rudimentary filtering on streaming data. The world mesh comprises a number of different points in three-dimensional (3D) space that correspond to points on objects in the environment viewed by the XR device.

Audio/video processing unit 311 in the embodiment shown may capture both video data and audio data and convert them into digital formats for further processing. Additionally, information regarding the depth of various objects observed in the real world of environment 340 may also be determined. Audio/video processor 311 is further configured to carry out 3D world modeling to allow XR device 305 to anchor virtual content to the physical world so virtual content appears in the same place relative to the physical world, no matter how the user moves their XR device 305. To achieve 3D world modeling with low network bandwidth overheads, XR device 311 performs the 3D modeling locally. Image frames from the XR device are marked with a unique identifier, timestamp, and camera pose indicating where they were captured before transmission to the server. The camera pose is determined by tracking algorithms specific to XR device 311, calculating its position relative to the local origin of the tracking space. Audio/video processing unit 311 is also configured to generate a world mesh of environment 340 using both the captured image frames and the depth sensing information from the depth sensor.

The frames captured by audio/video processing unit 311 may be added to user text queries for contextual information and forwarded to encoder 328. Since the position and pose of XR device 305 may be constantly changing, the world mesh may be updated correspondingly. The output of the decoder 328 may be paired with world mesh map to project content into the user's (potentially changed) view of the physical world.

Encoder 328 of server 325 is coupled in the embodiment shown to receive audio and image data from audio/video processing unit 311 of XR device 305. Decoder 315 of XR device 305 is coupled to receive text output from LLM processor 327 of server 325. Communications between XR device 305 and server 325 may be carried out using any suitable communications method/protocol. For example, XR device 305 and server 325 may communicate with one another via a cellular network, WiFi, or both.

In the embodiment shown, encoder 328 is responsible for converting audio to text and capturing frames of interest that should be passed to server 325 for processing in encoder 328 and LLM processor 327. As shown here, image data (which may be frames of video) and audio data are transferred from the sensors of XR device 311 to the encoder 328 running on server 325. It is noted that, in some embodiments, encoder 328 may be implemented on XR device 311 rather than on server 325, thereby reducing network overhead. Speech present in the audio data received by encoder 328 may be converted into text data using a speech-to-text module. To convert the audio data, the encoder 328 may perform ambient noise filtering and divide the audio stream into segments of a predetermined duration that may contain user queries. Each segment may be augmented with additional context. For instance, in a cognitive assistant application to be discussed below, transcribed text query may be augmented to include supplementary information like the current instruction set being executed.

When converting image data produced by XR device 305, multiple image frames at a time are selected for processing in LLM processor 327. These frames may show the present view of the physical world, as seen through XR device 305, as well as a snapshot of what previously happened in the physical world. Providing frames of the past and present grounds LLMs, executed in LLM processor 327, in the context of what has already happened.

The processed image and audio data may then be passed to LLM processor 327 for processing by one or more LLMs, which may include MLLMs capable of processing audio and image data in addition to text data in the form of prompts. In addition to the processing of image and audio data by encoder 328, a prompt generator 329 may translate the processed data into a prompt provided to the various LLMs run by LLM processor 327.

Both the prompt generated in prompt generator 329 and audio/video data processed in encoder 328 are sent to LLM processor 327. Since server 325 has ample computational resources compared to an XR device, a provided API may enable the execution of multiple MLLMs in parallel along with potential remote cloud calls. One example implementation may concurrently use GPT-4V [36] on OpenAI's servers and Ferret [32]. Ferret is a specialized MLLM, which can identify objects, discern relationships between multiple regions in an image, and provide 2D bounding boxes of object locations. In such an implementation, Ferret's spatial understanding may be combined with GPT-4V for reasoning, thereby optimizing the respective capabilities of both. These two models may be queried at the same time with LLM processor 327 combining the responses of both models, using GPT-4V's response for textual feedback and Ferret's response for object locations which are used to anchor AR content. Thus, the inference time is limited by the slowest MLLM, which is typically GPT-4V. This overhead can potentially be reduced with faster models like GPT-4o.

Decoder 315 as shown here is responsible for packaging the output received from LLM processor 327 into an intuitive visual interface. Simple language may be used for AR annotations provided by the prompting system of XR device 305 that can draw graphical primitives anchored at 3D locations in the world mesh based on environment 340. The system may include a small dictionary of arrows and text boxes, but may also include more complex models and scripted interactions. Decoder 315 may use the world mesh and camera pose information received from audio/video processing unit 311 along with the output from LLM processor 327 to generate 3D projections and augmented reality overlays. These may be projected into a HUD of XR device 305 to display information usable by a wearer of the device. In the example shown here, the information includes arrows and text indication locations at which a wearer of XR device 311 may place a potted plant.

One of the main challenges in processing image data is converting 2D coordinates into 3D coordinates. For example, 2D boxes generated by the Ferret model may require projection into 3D data in order to anchor AR content into the scene. XR device 305 in the example shown stores all the previous camera poses along with their associated image IDs in a lookup table. Once XR device 311 receives a response from server 325 with an image ID, it looks up the associated camera pose. Using this pose, it raycasts into the stored 3D world mesh to get the 3D coordinates of that object when the image was captured. The text output is also displayed on the screen for the user in AR. Because the XR device 305 internally tracks each virtual 3D object within the local tracking space, continual processing of each image to update the object locations is not required.

In one embodiment, since the objects are not actively tracked after frames are captured, the anchors may be rendered at fixed locations and are updated after processing new frames. Embodiments are possible and contemplated in which a post-processing step is added in XR device 305 that carried out continual tracking of certain objects that are known to be dynamic.

FIG. 3B is a diagram illustrating a method for operating one embodiment of system utilizing LLMs with an XR device. Method 350 as shown herein may be carried out by various embodiments of the XR device 305 and server 325 as discussed above with reference to FIG. 3A.

Method 350 includes a user wearing a headset (an XR device) and capturing data from the 3D physical world (block 352). The captured data of the 3D physical world is stored as a mesh in the XR device (block 354). Audio data and egocentric image data (i.e. image data from the perspective of the user of the XR device), tagged with a camera pose (i.e. position and orientation of objects), is then streamed to a server (block 356 and 358). In the server, a high-level task description is combined with the audio and egocentric image data to generate a prompt, which is fed to multiple LLMs (GPT-4V and Ferret) to generate a combined text response and coordinate response (block 360).

The LLM response and 2D image space coordinate information is then provided back to the XR device (block 362). In this example, the LLM response includes the text instructions “Place the red wire [obj1] into the right-most slot [obj2],” which is accompanied by corresponding overlays. This response is received at the XR device, and is raycast into the mesh of the 3D world previously generated (block 364). The XR device then receives the virtual annotations and places them into the environment (block 366), enabling the user to see and carry out the given instructions.

FIG. 3C is a flow diagram of one embodiment of a method for operating an XR device. Method 370 may be carried out by various embodiments of a system including an XR device in communications with a server or other system capable of running LLMs, including the system shown in FIG. 3A.

Method 370 includes capturing, in an environment and using an extended reality device, sensor data from a plurality of sensors of the extended reality device, wherein the sensor data includes image data, audio data, and depth data (block 372). The method further includes forming, using the sensor data, a world mesh corresponding to a three-dimensional geometric representation of the environment (block 374) and generating, based on the image data, pose data indicating respective positions and orientations of a plurality of objects present in the world mesh (block 376). The method also includes converting speech in the audio data into text data (block 378).

Using the text data and selected image data, the method further includes creating a prompt (block 380). Thereafter, the method includes executing, in parallel and using the prompt, a plurality of large language models (LLMs) to generate a text output (block 382). Method 370 also includes combining, in the extended reality device, the text output and a three-dimensional projection generated based on the world mesh and pose data to produce a visual output (block 384). The method then continues by displaying the visual output on a display of the extended reality device (block 386). Method 370 may be repeated for the duration of operation of the XR device.

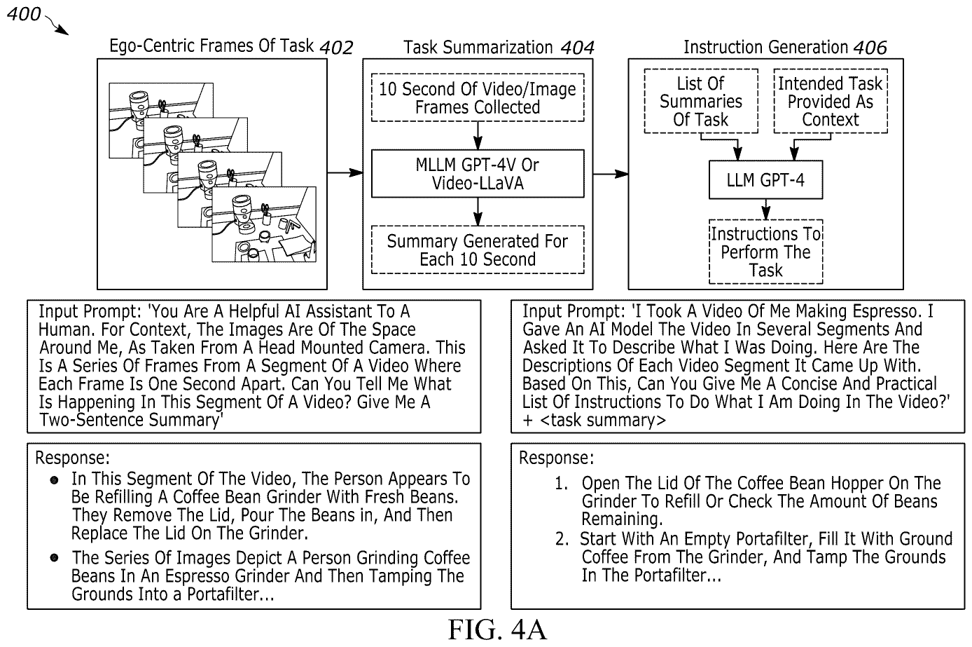

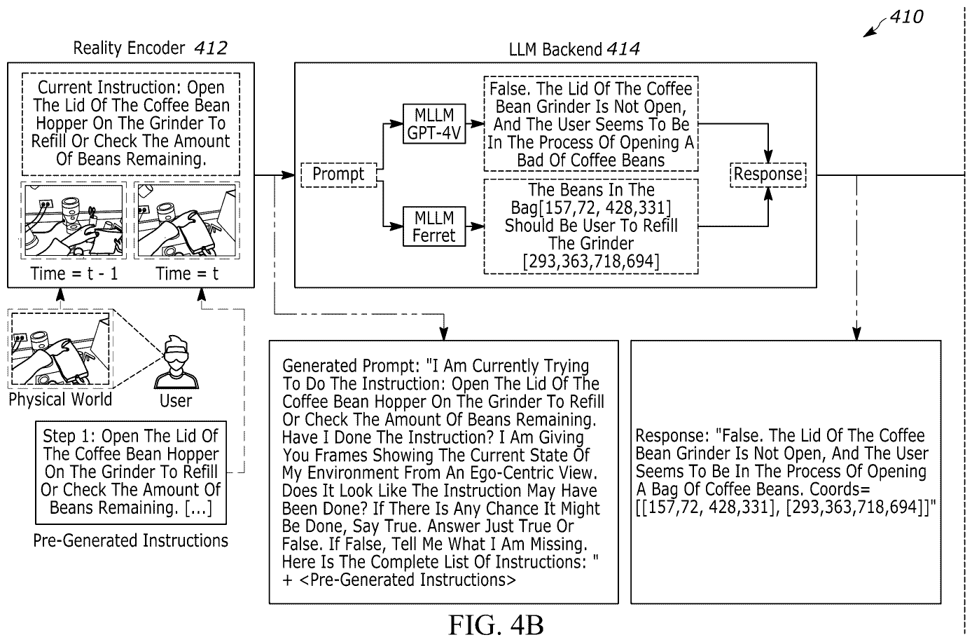

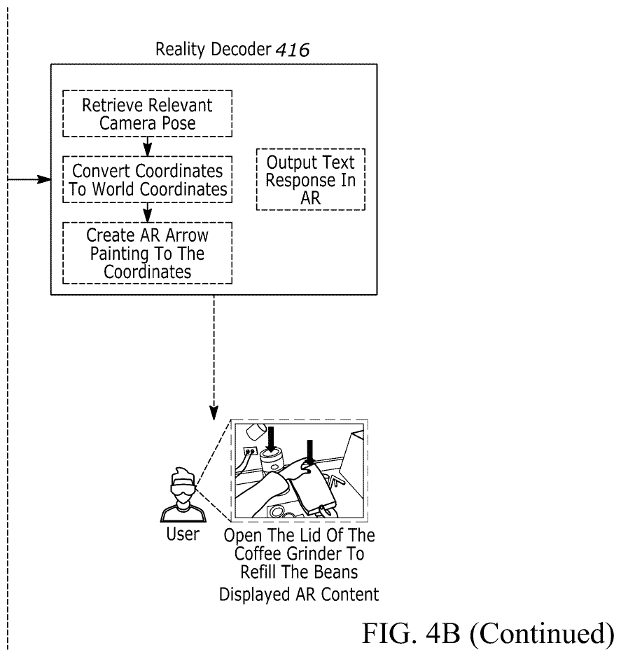

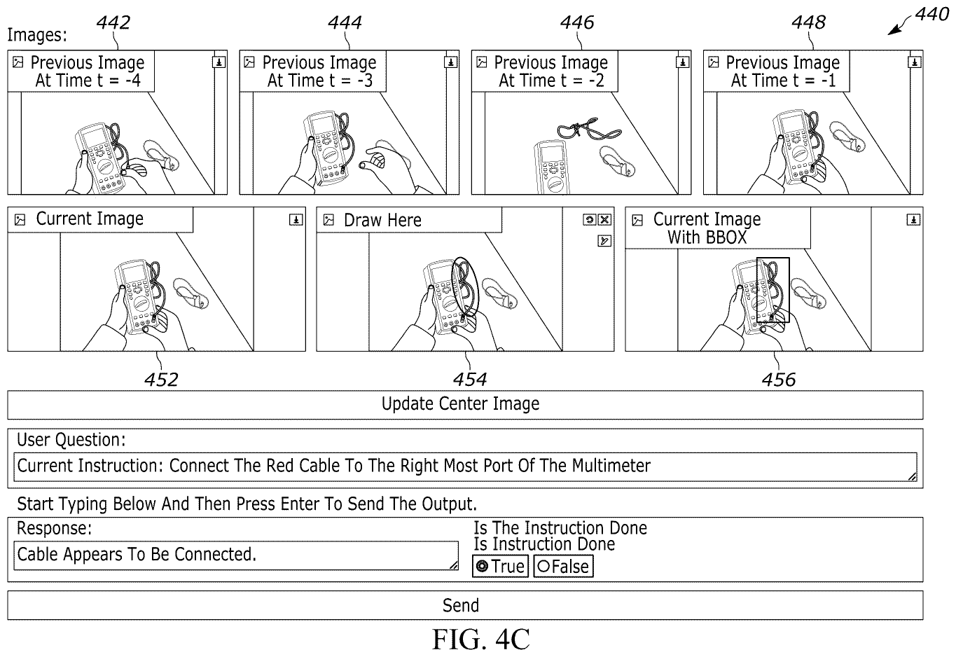

FIG. 4A is a diagram illustrating the operation of an application using an XR device and LLMs. More particularly, FIG. 4A illustrates an instruction generation pipeline for an example cognitive assistant application that utilizes the various method and apparatus embodiments disclosed herein. Included in this illustration are example input prompts and example output responses from the system (including from LLMs) at various steps. The particular task for this example comprises, on the left, a generation of summaries based on a first input prompt, and, on the right, generation of task steps based on a second input prompt.

In block 402, a number of egocentric image frames (sill images or frame from video) of the task are captured. The image frames may be captured using a camera of an XR device, e.g., a headset or glasses with video capability. In some embodiments, a depth sensing camera may be used to capture depth information for the various objects appearing in the frame, and the image frames may thus be tagged accordingly.

The captured images are used to perform task summation in block 404. The task summation in this non-limiting example includes utilizing 10-second blocks of video/image frames and applying these blocks to at least one MLLM. The example here utilizes at least one of the MLLMs GPT-4V or Video-LLaVA, although other MLLM types are possible and contemplated. For each of the 10-second segments, a summary may be generated by the utilized MLLM(s).

Instruction generation is then carried out in block 406. This includes an LLM, such as GPT-4, receiving a list of summaries of the task as well as the intended task being provided as context. These inputs are provided to the LLM, which responds with an output comprising instructions to perform the task.

FIG. 4B is a diagram further illustrating the operation of an application using an XR device and LLMs per process 410. The task for which instructions are generated in this non-limiting example is similar to that used for illustration in the example of provided by FIG. 4A.

In block 412, the encoder (referred to here as the “reality encoder”) receives inputs from the physical world via sensors of an XR device, the input including audio and video/image data. The encoder uses past data from time t-1 (for context) as well as the present data from time t to generate an instruction. In generation of the current instruction, a pre-generated instruction that was provided to a user of the XR device is also provided for context. A generated prompt is also produced based on the data provided to the encoder.

In block 414, LLM processing is performed using the data provided from the encoder step of 412. This data may include selected video/image data (e.g., selected frames of video captured by the XR device) and text converted from speech present in the audio data. Two different LLMs receive the generated prompt and perform processing based thereon an in accordance with their respective functions. In this non-limiting example, the GPT-4V MLLM generates an answer to the true/false query presented in the generated prompt, while the Ferret MLLM generates an answer, based on information from the video/image data, indicating the next portion of the task that is to be carried out. The results of the execution of the MLLMs are then combined into a unified response.

In block 416, a decoder (referred to here as the “reality decoder”) on the XR device receives the combined response generated from execution of the MLLMs based on the previously generated prompt. Using the combined output from the MLLMs, a processor on the XR device may retrieve video/image data having relevant camera pose, convert the coordinates within the image to world coordinates, and generate an AR overlay to be provided to a HUD of the XR device. Text with instructions is also generated for display within the AR overlay. The AR overlay and corresponding text is then displayed on the HUD of the XR device to indicate to the user the next steps in performing the task.

FIG. 4C is a diagram illustrating an example of a web-based dashboard for human assessment of performance of the system disclosed herein per dashboard 440. In particular, FIG. 4C illustrates an example of the dashboard to allow a human to assess the operation of the various LLMs in carrying out the intended operations of the systems described herein such that any further training, if desired, may be conducted.

In the illustrated example, frames 442-456 present image data from various times in a sequence, starting at time t-4 up to a present time t. Images 454 and 456 correspond to time t as well, and may be used to train an LLM to generate an AR overlay at a particular location within the image for carrying out a particular task. In image 454, and based on the instruction, a user of the dashboard indicates through a sketch on the image a position where an AR overlay is to be presented. In image 456, a corresponding AR overlay based on the sketch is shown.

Dashboard 440 also shows the instruction and a response, with a true/false selection in which a trainer of the LLM may indicate whether the particular instruction has been carried out as intended. The trainer may then press the send button to store the response. This may be carried out for other instructions as well, allowing a trainer to train the LLM and thus configured the various systems discussed herein to aid a user of an XR device to carry out specific tasks under the direction of LLMs.

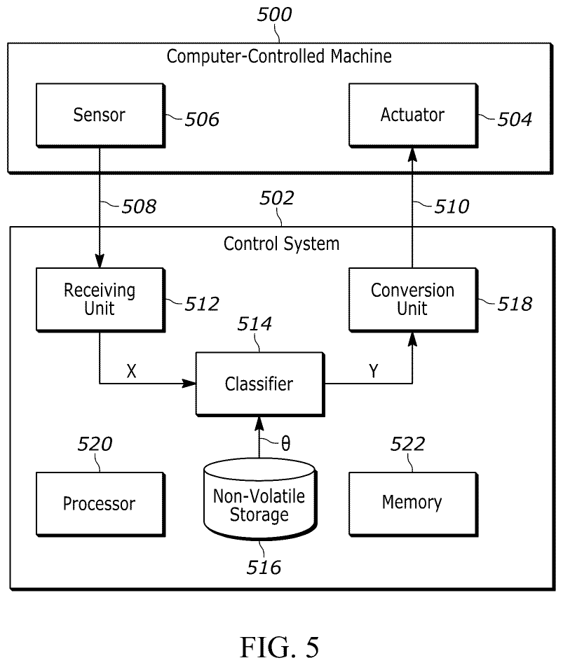

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500 or a process carried out thereby. Sensor 506 may be configured to encode the sensed condition into sensor signals 508 and to transmit sensor signals 508 to control system 502. Non-limiting examples of sensor 506 include sensors utilized with an XR device (e.g., an XR headset) including audio sensors, video sensors, depth-sensing cameras, and so on. Other types of sensors are also possible and contemplated, such as ultrasonic sensors, motion sensor, thermal imaging sensors, and so on. Embodiments in which a combination of different sensors are possible and contemplated.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500. Control system 502 may include a PLC as discussed elsewhere herein, while computer-controlled machine 500 may be industrial equipment configured to carry out an automated industrial process.

As shown in FIG. 5, control system 502 also includes processor 520 and memory 522. Processor 520 may include one or more processors, and at least one of these processors may comprise a PLC. Memory 522 may include one or more memory devices. The classifier 514 of one or more embodiments may be implemented by control system 502, which includes non-volatile storage 516, processor 520 and memory 522. As an alternative or an addition to classifier 514, one or more LLMs (including MLLMs) may be included.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for operating an extended reality device, the method comprising:
capturing, in an environment and using the extended reality device, sensor data from a plurality of sensors of the extended reality device, wherein the sensor data includes image data, audio data, and depth data;
forming, using the sensor data, a world mesh corresponding to a three-dimensional geometric representation of the environment;
generating, based on the image data, pose data indicating respective positions and orientations of a plurality of objects present in the world mesh;
converting speech in the audio data into text data;
creating, using the text data and selected image data, a prompt;
executing, in parallel and using the prompt, a plurality of large language models (LLMs) to generate a text output;
combining, in the extended reality device, the text output and a three-dimensional projection, based on the world mesh and the pose data, to produce a visual output; and
displaying the visual output on a display of the extended reality device.

2. The method of claim 1, wherein the plurality of LLMs include at least one multi-modal LLM.

3. The method of claim 1, wherein executing the plurality of LLMs is performed on a server that is remote with respect to the extended reality device.

4. The method of claim 1, further comprising forming the world mesh and generating the pose data using the extended reality device.

5. The method of claim 1, wherein the selected image data comprises selected ones of a plurality of frames from video data captured by a camera of the extended reality device.

6. The method of claim 1, wherein the visual output comprises an augmented reality overlay displayed to a user of the extended reality device.

7. The method of claim 6, wherein the visual output further comprises text information associated with the augmented reality overlay.

8. The method of claim 1, further comprising at least one of the plurality of LLMs using the audio data and the selected image data.

9. The method of claim 1 further comprising performing the converting of audio speech into the text data and selecting portions of the image data on a server remote from the extended reality device.

10. The method of claim 1, further comprising creating the prompt based on a high-level task description.

11. A system for performing extended reality functions, the system comprising:
an extended reality device, wherein the extended reality device includes:
a plurality of sensors configured to capture sensor data, the plurality of sensors including a camera configured to capture image data, a microphone configured to capture audio data, and a depth-sensor configured to capture depth data corresponding to objects present in an environment in which the extended reality device is operating;
a processor, the processor is configured to:
form, using the sensor data, a world mesh corresponding to a three-dimensional geometric representation of the environment;
generate, based on the image data, pose data indicating respective positions and orientations of a plurality of objects present in the world mesh;
produce a visual output based on combining a text output from a plurality of large-language models (LLMs) and a three-dimensional projection based on the world mesh and the pose data, wherein the plurality of LLMs are executed based on text data converted from speech in the audio data, selected portions of the image data, and a prompt generated using the text data and the selected portions of the image data; and
display the visual output on a display of the extended reality device.

12. The system of claim 11, further comprising a server located remotely with respect to the extended reality device, wherein the server is configured to:
generate the prompt based on the text data and the selected portions of the image data;
execute the plurality of LLMs using the text data, the audio data, and the selected portions of the image data; and
provide the text output from execution of the plurality of LLMs to the extended reality device.

13. The system of claim 12, wherein the server is further configured to:
convert the speech in the audio data into the text data; and
select particular ones of a plurality of frames of image data to produce the selected portions of the image data.

14. The system of claim 12, wherein the server is further configured to generate the prompt based on a high-level task description.

15. The system of claim 11, wherein the visual output comprises an augmented reality overlay viewable on the display of the extended reality device.

16. The system of claim 15, wherein the visual output further comprises text associated with the augmented reality overlay.

17. The system of claim 11, wherein the extended reality device is further configured to store previous instances of pose data and associated image identifiers.

18. A method for generating visual content on a display of an extended reality device, the method comprising:
capturing, using a plurality of sensors of the extended reality device, sensor data, the sensor data including audio data, image data, and depth data corresponding to objects present in an environment in which the extended reality device is operating;
forming, using the sensor data, a world mesh corresponding to a three-dimensional geometric representation of the environment;
generating, based on the image data, pose data indicating respective positions and orientations of a plurality of objects present in the world mesh;
producing a visual output based on combining a text output from a plurality of large-language models (LLMs) and a three-dimensional projection based on the world mesh and the pose data, wherein the plurality of LLMs are executed based on text data converted from speech in the audio data, selected portions of the image data, and a prompt generated using the text data and the selected portions of the image data; and
display the visual output on the display of the extended reality device.

19. The method of claim 18, further comprising:
conveying the image data and the audio data to a server located remotely with respect to the extended reality device; and
executing the plurality of LLMs on the server.

20. The method of claim 19, further comprising:
converting, on the server, the speech in the audio data into the text data; and
selecting, on the server, particular ones of a plurality of frames of image data to produce the selected portions of the image data.
